(19) United States
(12) Patent Application Publication
(10) Pub. No.: US 2021/0096743 A1
(43) Pub. Date: Apr. 1, 2021

(54) CONTROL METHOD OF ELECTRONIC DEVICE

(71) Applicant: ASUSTEK COMPUTER INC., Taipei (TW)

(72) Inventors: Chia-Fan HOU, TAIPEI (TW); Sheng-Ta LIN, TAIPEI (TW)

(21) Appl. No.: 17/033,276

(22) Filed: Sep. 25, 2020

Related U.S. Application Data
(60) Provisional application No. 62/906,466, filed on Sep. 26, 2019.

(30) Foreign Application Priority Data
Jul. 8, 2020 (TW) 109122965

(51) Int. Cl. G06F 3/0488; G06F 3/14; G06F 3/01

(52) U.S. Cl. CPC G06F 3/04886; G06F 3/017; G06F 3/1454

(57) ABSTRACT

A control method of an electronic device is provided. The electronic device has an input unit and a display unit. The control method includes: displaying a user interface on the display unit, the user interface having a function event; receiving an execution command corresponding to the function event through the input unit, and displaying a window in response to the execution command on the display unit; and receiving a disable command corresponding to the function through the input unit, and displaying an execution result in response to the disable command on the display unit. At least one of the execution command and the disable command is a gesture.

### CROSS-REFERENCE TO RELATED APPLICATION

This application claims the priority benefit of U.S. Provisional Application Ser. No. 62/906,466 filed on Sep. 26, 2019 and TW Application Serial No. 109122965 filed on Jul. 8, 2020. The entirety of the above-mentioned patent application is hereby incorporated by reference herein and made a part of the specification.

### BACKGROUND OF THE INVENTION

### Field of the Invention

The disclosure relates to a control method, and in particular, to a control method of an electronic device.

### Description of the Related Art

Computers provide a variety of functions. These functions are triggered through different instructions. Users need to memorize the instructions to trigger a certain function for operation. Therefore, it is inconvenient.

### BRIEF SUMMARY OF THE INVENTION

The disclosure provides a control method of an electronic device. The electronic device has an input unit and a display unit. The control method comprises the following steps: displaying a user interface on the display unit, the user interface having a function event; receiving an execution command that corresponds to the function event through the input unit, and displaying a window in response to the execution command on the display unit; and receiving a disable command that corresponds to the function event through the input unit, and displaying an execution result in response to the disable command on the display unit; wherein at least one of the execution command and the disable command is a gesture.

The control method provided in the disclosure performs a function event menu by receiving an execution command (for example, a specified gesture) through an input unit, and receives a subsequent command, such as a disable command through the input unit to perform a subsequent step. The control method of the disclosure simplifies operation steps and improves the convenience.

### BRIEF DESCRIPTION OF THE DRAWINGS

FIG. 1 is a schematic block diagram of an embodiment of an electronic device to which a control method of an electronic device is applied according to the disclosure;

FIG. 2 is a flowchart of a first embodiment of the control method of an electronic device according to the disclosure;

FIG. 3 is a flowchart of an embodiment of enabling a user interface by a gesture;

FIG. 4 is a flowchart of a second embodiment of the control method of an electronic device according to the disclosure;

FIG. 5 is a flowchart of a third embodiment of the control method of an electronic device according to the disclosure;

FIG. 6 is an operating flowchart of an embodiment of an automatic virtual private network (VPN) connecting function; and

FIG. 7 is a flowchart of a fourth embodiment of the control method of an electronic device according to the disclosure.

### DETAILED DESCRIPTION OF THE EMBODIMENTS

Specific embodiments of the disclosure are described in further detail below with reference to the accompanying drawings. The advantages and features of the disclosure will become more apparent from the following descriptions and claims. It is to be noted that the drawings are all in a very simplified form and are not drawn to accurate scale, but are merely used for convenience and clarity of description of the embodiments of the disclosure.

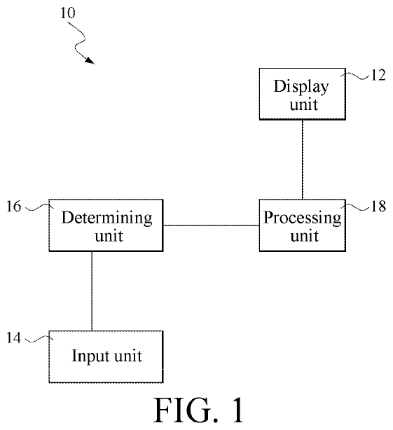

FIG. 1 is a schematic block diagram of an embodiment of an electronic device to which a control method of an electronic device is applied according to the disclosure. The electronic device 10 is a notebook computer, a tablet computer, or other electronic devices supporting gestures input.

As shown in the figure, the electronic device 10 includes a display unit 12, an input unit 14, a determining unit 16, and a processing unit 18. The determining unit 16 is electrically connected to the input unit 14 to receive a command from the input unit 14 for determining. In an embodiment, the determining unit 16 is a hardware circuit, a software program, or a combination thereof. In an embodiment, the input unit 14 is a touch pad, a touch panel, a keyboard, or a combination thereof. In an embodiment, the command from the input unit 14 is a gesture command or a key input command.

The processing unit 18 is electrically connected to the determining unit 16 and the display unit 12. It is determined through the determining unit 16 whether the command from the input unit 14 matches a preset command or not, and thus to present a user interface, information, or an execution result corresponding to the command on the display unit 12.

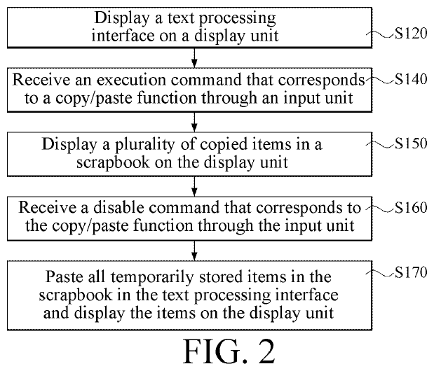

FIG. 2 is a flowchart of a first embodiment of the control method of an electronic device according to the disclosure. The control method is applied to the electronic device 10 shown in FIG. 1. The control method in this embodiment is a control method that applies to a text processing function. The control method includes the following steps that are described in the paragraphs below.

First, in step S120, a text processing interface (that is, a user interface) is displayed on the display unit 12. The text processing interface includes a plurality of function events, including at least a copy/paste function. The text processing interface is started by the electronic device 10 automatically after power on, or is started by a user. In an embodiment, the step is performed by the processing unit 18 in FIG. 1. In an embodiment, the step is jointly performed by the processing unit 18 and the determining unit 16 in FIG. 1.

Next, in step S140, an execution command corresponding to the copy/paste function is received through the input unit 14. Subsequently, in step S150, a plurality of recent copied items stored in a scrapbook (that is, a window in response to the execution command) is displayed on the display unit 12 for the user to choose and confirm. In an embodiment, the execution command is a key input command of “Ctrl+C”. In an embodiment, step S150 is performed by the processing unit 18 in FIG. 1.

Next, in step S160, a disable command corresponding to the copy/paste function is received through the input unit 14. Subsequently, in step S170, all temporarily stored items in the scrapbook are pasted in the text processing interface (that is, an execution result in response to the disable command) and presented on the display unit 12. In an embodiment, the disable command is a gesture. In an embodiment, step S170 is performed by the processing unit 18 in FIG. 1. In an embodiment, in step S170, all the temporarily stored items in the scrapbook are reversely pasted in the text processing interface and presented on the display unit. In an embodiment, in step S170, each copied item automatically wraps around during the information pasting process.

Conventionally, the scrapbook needs to be opened repeatedly for clicking different items to paste a plurality of pieces of copied items. In comparison, in this embodiment, all repetitive actions are integrated, so that the user pastes all contents in the scrapbook with only one gesture.

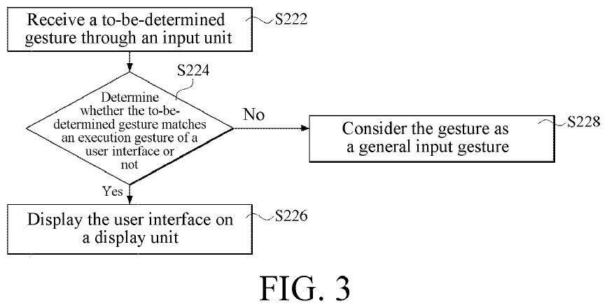

FIG. 3 is a flowchart of an embodiment of enabling a user interface by a gesture. Steps shown in the figure correspond to step S120 in FIG. 2.

First, in step S222, a to-be-determined gesture is received through the input unit 14.

Next, in step S224, it is determined whether the to-be-determined gesture matches an execution gesture of the user interface or not. In an embodiment, the step is performed by the determining unit 16 in FIG. 1.

When the to-be-determined gesture matches the execution gesture of the user interface, as shown in step S226, the user interface is displayed on the display unit 12. In an embodiment, the step is performed by the processing unit 18 in FIG. 1.

When the to-be-determined gesture does not match the execution gesture of the user interface, as shown in step S228, the processing unit 18 considers the to-be-determined gesture as a general input gesture.

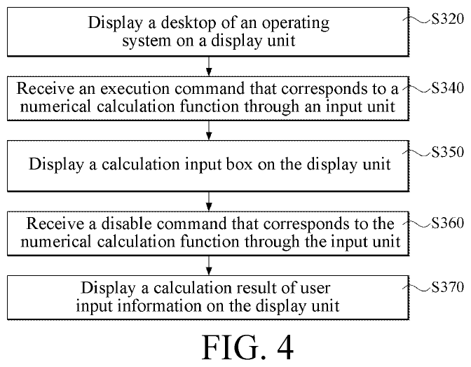

FIG. 4 is a flowchart of a second embodiment of the control method of an electronic device according to the disclosure. The control method is applied to the electronic device 10 shown in FIG. 1. The control method in this embodiment is a control method that applies to a numerical calculation function of an operating system. The numerical calculation function includes metric conversion, currency conversion, formula calculation, and the like. In this embodiment, the control method is also applied to a network query function of the operating system. The control method includes the following steps.

First, in step S320, a desktop of an operating system (that is, a user interface) is displayed on the display unit 12. The desktop of the operating system includes a plurality of function events, including at least the numerical calculation function. In an embodiment, the step is performed by the processing unit 18 in FIG. 1.

Next, in step S340, an execution command corresponding to the numerical calculation function is received through the input unit 14. Subsequently, in step S350, a calculation input box (that is, a window in response to the execution command) is displayed on the display unit 12 for the user to input. In an embodiment, the execution command is a gesture. In an embodiment, step S350 is performed by the processing unit 18 in FIG. 1.

Next, in step S360, a disable command is received through the input unit 14. The disable command corresponds to the numerical calculation function that is triggered by, for example, an “Enter” key, indicates that the user has finished inputting. Subsequently, in step S370, a calculation result of user input information (that is, an execution result in response to the disable command) is presented on the display unit 12. In an embodiment, step S370 is performed by the processing unit 18 in FIG. 1.

Conventionally, different programs are used according to different contents that are queried for, or a menu item needs be selected first. In comparison, in the disclosure, all queries are directly conducted at the same portal, so that user operation is simplified.

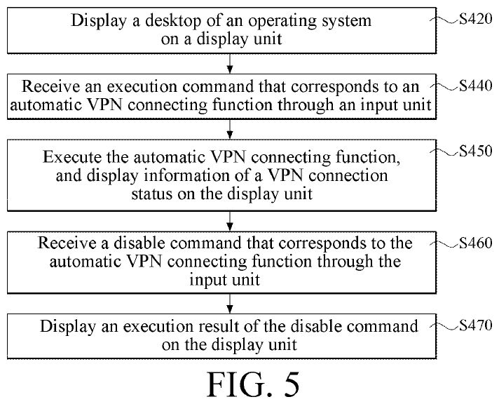

FIG. 5 is a flowchart of a third embodiment of the control method of an electronic device according to the disclosure. The control method is applied to the electronic device 10 shown in FIG. 1. The control method in this embodiment is a control method that applies to a VPN connecting function of an operating system. The control method includes the following steps.

First, in step S420, a desktop (that is, a user interface) of an operating system is displayed on the display unit 12. The desktop of the operating system includes a plurality of function events, including at least the automatic VPN connecting function. In an embodiment, the step is performed by the processing unit 18 in FIG. 1.

Next, in step S440, an execution command corresponding to the automatic VPN connecting function is received through the input unit 14 to execute the automatic VPN connecting function. Subsequently, in step S450, the automatic VPN connecting function is executed, and information of a VPN connection status (that is, a window in response to the execution command) is displayed on the display unit 12. In an embodiment, the execution command is a gesture. In an embodiment, step S450 is performed by the processing unit 18 in FIG. 1.

Next, in step S460, a disable command corresponding to the automatic VPN connecting function is received through the input unit 14 to break the VPN connection. Subsequently, in step S470, an execution result of the disable command, for example, a page informing that the automatic VPN connecting function is disabled, is presented on the display unit 12. The automatic VPN connecting function in step S450 is continuously executed until VPN connection succeeds or the processing unit 18 receives the disable command through the input unit 14. In an embodiment, the disable command is a gesture. In an embodiment, step S470 is performed by the processing unit 18 in FIG. 1.

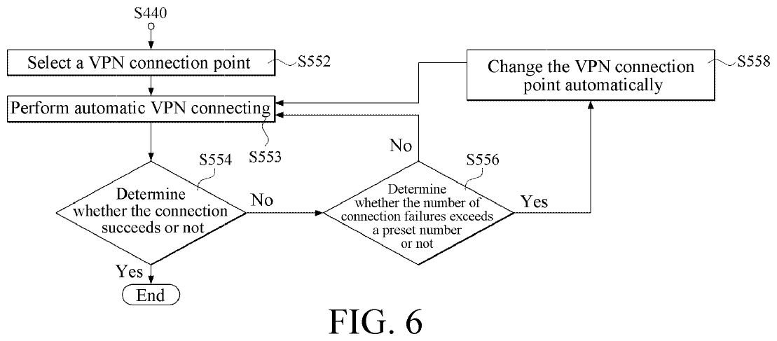

Also referring to FIG. 6, FIG. 6 is an operating flowchart of an embodiment of the automatic VPN connecting function. Following step S440 in FIG. 5, as shown in step S552, in the process, after receiving the execution command corresponding to the automatic VPN connecting function, a VPN connection point is selected first. Next, as shown in step S553, the automatic VPN connection function is executed according to the VPN connection point. In an embodiment, the selected connection point in step S552 is a recent VPN connection point.

Subsequently, as shown in step S554, whether the connection succeeds is determined or not. When the connection succeeds, the process ends. When the connection fails, the process goes to step S556.

In step S556, it is determined in the process whether the number of connection failures exceeds a preset number, for example, three, or not. When the number of connection failures exceeds the preset number, the process goes to step S558 to automatically change the VPN connection point. Subsequently, connection is automatically performed according to a changed-to VPN connection point. When the number of connection failures does not exceed the preset number, the process goes to step S553 to continue the connection. In an embodiment, the changed-to VPN connection point is a recent connection point recorded other than the connection point that fails last time.

The process is continuously performed until VPN connection succeeds or the processing unit 18 receives the disable command on the input unit 14.

Conventionally, a setting path of an interface is complex, and a relatively large number of operation steps are involved. In the disclosure, all paths and operation steps are integrated into gestures to simplify user operation. In addition, conventionally, when connection fails, manual changing is needed. In the disclosure, reconnection is performed automatically, and another connection point is automatically selected after a plurality of failures.

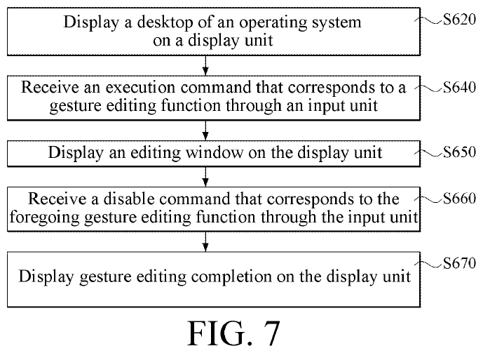

FIG. 7 is a flowchart of a fourth embodiment of the control method of an electronic device according to the disclosure. The control method is applied to the electronic device 10 shown in FIG. 1. The control method in this embodiment is a control method that applies to gesture editing. The control method includes the following steps.

First, in step S620, a desktop of an operating system (that is, a user interface) is displayed on the display unit 12. The desktop of the operating system includes a gesture editing function for a user to edit a gesture to facilitate gesture input. In an embodiment, the step is performed by the processing unit 18 in FIG. 1.

Next, in step S640, an execution command corresponding to the gesture editing function is received through the input unit 14. Subsequently, in step S650, an editing window (a window in response to the execution command) is displayed on the display unit 12 for the user to perform editing, for example, recording or modifying gesture information. In an embodiment, the execution command is a gesture. In an embodiment, step S650 is performed by the processing unit 18 in FIG. 1. In an embodiment, the editing window includes a recording function, different operation adjusting options, and a saving function.

Next, in step S660, a disable command corresponding to the gesture editing function, for example, an “Enter” key or a key input command of ending recording, indicating that the user has finished recording or modifying, is received through the input unit 14. Subsequently, in step S670, gesture editing completion (that is, an execution result in response to the disable command) is displayed on the display unit 12. In an embodiment, in step S670, the user may directly exit the editing window, or a dialog box inquiring whether to save the editing is displayed on the display unit 12. In an embodiment, step S670 is performed by the processing unit 18 in FIG. 1.

Conventionally, when users want to adjust specific items, different windows have to be operated one by one. In the disclosure, different operations are integrated into gestures, making it convenient for the user to operate.

The control method provided in the disclosure performs a function event menu by receiving an execution command (for example, a specified gesture) through the input unit 14 (for example, a touchpad), and receives a subsequent command such as a disable command through the input unit 14 (for example, the touchpad) to perform a subsequent operation. The control method of the disclosure simplifies operation steps and improves the convenience.

The foregoing descriptions are merely exemplary embodiments of the disclosure and are not intended to limit the disclosure in any way. Any person skilled in the art can make any form of equivalent replacement or modification to the technical means and technical contents disclosed in the disclosure without departing from the scope of the technical means of the disclosure, and such an equivalent replacement or modification does not depart from the contents of the technical means of the disclosure and falls within the protection scope of the disclosure.

What is claimed is:

1. A control method of an electronic device, applied to an electronic device having an input unit and a display unit, the control method comprising:
displaying a user interface on the display unit, the user interface having a function event;
receiving an execution command that corresponds to the function event through the input unit, and displaying a window in response to the execution command on the display unit; and
receiving a disable command that corresponds to the function event through the input unit, and displaying an execution result in response to the disable command on the display unit,
wherein at least one of the execution command and the disable command is a gesture.

2. The control method of an electronic device according to claim 1, wherein the step of displaying a user interface on the display unit comprises:
receiving a to-be-determined gesture through the input unit;
determining whether the to-be-determined gesture matches an execution gesture of the user interface or not; and
when the to-be-determined gesture matches the execution gesture of the user interface, displaying the user interface on the display unit.

3. The control method of an electronic device according to claim 1, wherein the user interface is a text processing interface, and the function event is a copy/paste function.

4. The control method of an electronic device according to claim 3, wherein the displaying a window in response to the execution command on the display unit further comprises: displaying a plurality of recent copied items stored in a scrapbook of the copy/paste function on the display unit.

5. The control method of an electronic device according to claim 1, wherein the user interface is a desktop of an operating system, and the function event is a numerical calculation function.

6. The control method of an electronic device according to claim 5, wherein the execution command is the gesture.

7. The control method of an electronic device according to claim 1, wherein the user interface is a desktop of an operating system, and the function event is an automatic virtual private network (VPN) connecting function.

8. The control method of an electronic device according to claim 7, wherein the execution command and the disable command are the gestures.

9. The control method of an electronic device according to claim 1, wherein the user interface is a desktop of an operating system, and the function event is a gesture editing function.
